(19) United States
(12) Patent Application Publication
(10) Pub. No.: US 2007/0034505 A1
(43) Pub. Date: Feb. 15, 2007

(54) Electrode for electrolysis and method of manufacturing electrode for electrolysis

(76) Inventors: Mineo Ikematsu, Tsuchiura-shi (JP); Kazuhiro Kaneda, Fukaya-shi (JP)

Correspondence Address: MCDERMOTT WILL & EMERY LLP, 600 13TH STREET, N.W., WASHINGTON, DC, 20005-3096, US

(21) Appl. No.: 11/502,618

(22) Filed: Aug. 11, 2006

(30) Foreign Application Priority Data
Aug. 11, 2005 (JP) 2005-233535

(51) Int. Cl. C25C 7/02; C25B 11/03; B05D 3/02; B05D 1/36

(52) U.S. Cl. 204/280; 204/283; 427/372.2; 427/402

(57) ABSTRACT

An object is to provide an electrode for electrolysis capable of generating ozone water with a high efficiency by electrolysis of water at a low current density. An ozone generating electrode includes: a substrate; and a surface layer formed on the surface of the substrate and including a dielectric material, the surface layer includes holes which inwardly continuously extend from the surface of the surface layer, and a distance from the hole closest to the surface of the substrate to the surface of the substrate is more than 0 and 2000 nm or less.

### BACKGROUND OF THE INVENTION

1. Field of the Invention

The present invention relates to an electrode for electrolysis for use in an industrial or household electrolysis process, and a method of manufacturing the electrode for electrolysis.

2. Description of the Related Art

In general, ozone is a substance having a very strong oxidizing power. There is expected broad utilization of water in which ozone has been dissolved, so-called ozone water in a cleaning and sterilizing treatment, such as application of ozone water to water supply and sewage systems or foods or application of ozone water to a cleaning treatment in a semiconductor device manufacturing process or the like. As a method of generating ozone water, there are known: a method of dissolving, in water, ozone generated by ultraviolet irradiation or electric discharge; a method of generating ozone in water by electrolysis of water and the like.

In Japanese Patent Application Laid-Open No. 11-77060, there is disclosed an ozone water generating device including: ozone generating means for generating an ozone gas by use of an ultraviolet lamp; and a tank which stores water. In the device, the generated ozone gas is fed to water in the tank to thereby generate ozone water. In Japanese Patent Application Laid-Open No. 11-333475, there is disclosed an ozone water generating device which mixes, at a predetermined ratio by a mixing pump, an ozone gas generated by an electric discharge type of ozone gas generating device and water in order to dissolve the ozone gas in water with a good efficiency.

However, in the above-described ozone water generating method in which the ozone gas is generated by the ultraviolet lamp or the electric discharge system as described above to dissolve this ozone gas in water, there is required the ozone gas generating device or an operation for dissolving the ozone gas in water, and the device easily becomes complicated. In this method, since the generated ozone gas is dissolved in water, there is a problem that it is difficult to generate ozone water having a desired concentration with a high efficiency.

In Japanese Patent Application Laid-Open No. 2002-80986, as a method for solving the above problem, there is disclosed a method of generating ozone in water by electrolysis of water to obtain ozone water. In such a method, there is used an ozone generating electrode including: an electrode substrate constituted of a porous or net-like material; and an electrode catalyst containing an oxide of a platinum group element or the like.

In the above-described method of generating ozone water by the electrolysis of water, however, the platinum group element is a standard anode material, and has a characteristic that the element is hardly dissolved in an aqueous solution which does not contain any organic substance. However, the element has a low ozone generating efficiency for the ozone generating electrode, and it is difficult to generate ozone water by a high-efficiency electrolysis method. When ozone water is generated by the electrolysis method using such a conventional ozone generating electrode, electrolysis at a high current density is required for generating ozone, and there is a problem in energy consumption or electrode life.

In consequence, the present invention has been developed in order to solve the conventional technical problem, and there is provided: an electrode for electrolysis, capable of generating ozone water with a high efficiency by electrolysis of water at a low current density.

### SUMMARY OF THE INVENTION

In a first aspect of the present invention, an electrode for electrolysis comprises: a substrate; and a surface layer formed on the surface of the substrate and including a dielectric material, wherein the surface layer includes holes which inwardly continuously extend from the surface of the surface layer, and a distance from the hole closest to the surface of the substrate to the surface of the substrate is more than 0 and 2000 nm or less.

In the electrode for electrolysis of a second aspect of the present invention, in the above invention, the substrate is a conductive substrate.

In the electrode for electrolysis of a third aspect of the present invention, in the above inventions, the dielectric material included in the surface layer is an oxide.

In the electrode for electrolysis of a fourth aspect of the present invention, in the above invention, the oxide is tantalum oxide, aluminum oxide, titanium oxide or tungsten oxide.

In the electrode for electrolysis of a fifth aspect of the present invention, in the electrode for electrolysis of any one of the above inventions, on the substrate, there is formed an intermediate layer positioned on an inner side of the surface layer, formed on the surface of the substrate and containing at least one of an oxidization retarding metal, a metal oxide having conductivity and a metal having conductivity even when oxidized, and the distance from the hole closest to the intermediate layer to the intermediate layer is more than 0 and 2000 nm or less.

In the electrode for electrolysis of a sixth aspect of the present invention, in the above invention, the intermediate layer contains one of a noble metal, an alloy including the noble metal and a noble metal oxide.

In the electrode for electrolysis of a seventh aspect of the present invention, in the above invention, the noble metal is platinum.

An eighth aspect of the present invention is a method of manufacturing an electrode for electrolysis in the fifth to seventh aspects of the present invention, the method including: a first step of applying an intermediate layer constituting material to the surface of a substrate, and thermally treating the surface of the substrate to form an intermediate layer on the surface of the substrate; and a second step of applying a surface layer constituting material to the surface of the intermediate layer, and thermally treating the surface of the intermediate layer in an oxidizing atmosphere to form a surface layer on the surface of the intermediate layer.

In a ninth aspect of the present invention, in the above invention, the thermal treatment in the second step is executed at a temperature higher than that of the thermal treatment in the first step.

According to the first aspect of the present invention, the electrode for electrolysis comprises the substrate, and the surface layer formed on the surface of the substrate and including the dielectric material, the surface layer includes holes which continuously extend from the surface of the surface layer into the inside of the surface layer, and a distance from the hole closest to the surface of the substrate to the surface of the substrate is more than 0 and 2000 nm or less. The electrode for electrolysis can perform the electrolysis to efficiently generate ozone at a low current density.

Especially the distance from the hole closest to the surface of the substrate to the surface of the substrate is more than 0 and 2000 nm or less. Therefore, electrons can move in the electrode via an impurity level positioned from the holes to the substrate surface in the surface layer, or owing to the Fowler-Nordheim tunnel. Accordingly, in an electrode reaction in an anode, an empty level in the vicinity of the bottom of a conduction band has an energy level which is higher than the Fermi level as much as about a half of a band gap, can receive the electrons from an electrolyte, and excites the movement of the electrons at a higher energy level. Accordingly, ozone can efficiently be generated at a lower current density.

According to the electrode for electrolysis of the second aspect of the present invention, in the above invention, the substrate is the conductive substrate. Therefore, the electrons which have moved in the surface layer in the above invention can excite an electrode reaction. In consequence, ozone can efficiently be generated.

Moreover, according to the third aspect of the invention, in the above inventions, the dielectric material included in the surface layer is the oxide. Especially, as in the fourth aspect of the invention, the oxide is tantalum oxide, aluminum oxide, titanium oxide or tungsten oxide. Therefore, at the low current density, ozone can more effectively be generated.

Furthermore, according to the fifth aspect of the invention, in the above inventions, on the substrate, there is formed the intermediate layer positioned on the inner side of the surface layer, formed on the surface of the substrate and containing at least one of the oxidization retarding metal, the metal oxide having the conductivity and the metal having the conductivity even when oxidized. Therefore, in a case where the electrolysis is performed by the electrode, it is possible to avoid a disadvantage that the intermediate layer is oxidized and passivated. In consequence, durability of the electrode can be improved. As compared with a case where the whole substrate is constituted of the material constituting the intermediate layer, production cost can be reduced. Even in such a case, ozone can similarly efficiently be generated.

In addition, in the above invention, the distance from the hole closest to the intermediate layer to the intermediate layer is more than 0 and 2000 nm or less. Therefore, as described above, the electrons can effectively move in the surface layer. Therefore, in the surface of the surface layer, the electrode reaction can be excited at the high energy level. In consequence, it is possible to efficiently generate ozone at the lower current density.

According to the sixth aspect of the invention, the intermediate layer contains one of the noble metal, the alloy including the noble metal and the noble metal oxide. Especially, as in the seventh aspect of the invention, the intermediate layer contains platinum. Accordingly, when the electrolysis is performed by the electrode, it is possible to more efficiently generate ozone.

According to the eighth aspect of the invention, to manufacture the electrode for electrolysis in the fifth to seventh aspects of the invention, the method includes: the first step of applying the intermediate layer constituting material to the surface of the substrate, and thermally treating the surface of the substrate to form the intermediate layer on the surface of the substrate; and the second step of applying the surface layer constituting material to the surface of the intermediate layer, and thermally treating the surface of the intermediate layer in the oxidizing atmosphere to form the surface layer on the surface of the intermediate layer. Therefore, an appropriate amount of the intermediate layer having an appropriate thickness can be formed on the surface of the substrate with a good in-plane homogeneity. Moreover, it is possible to form the intermediate layer having a high close contact property.

Moreover, since it is possible to easily obtain the thickness of the intermediate layer in accordance with durability necessary for the electrode, a use amount of the intermediate layer constituting material can be set to be appropriate, and wasteful use can be reduced.

Furthermore, the appropriate amount of the surface layer having the appropriate thickness can be formed on the surface of the intermediate layer with the good in-plane homogeneity. Moreover, the surface layer having the high close contact property can be formed.

According to the ninth aspect of the invention, since the thermal treatment in the second step is executed at the temperature higher than that of the thermal treatment in the first step, the surface layer can be crystallized. When the surface layer is crystallized, an inner stress enlarges, and holes, so-called cracks can be formed in the surface layer.

When the cracks complicatedly repeat branching and combining, it is possible to form the cracks in which the distance from the hole closest to the intermediate layer to the intermediate layer is more than 0 and 2000 nm or less. Therefore, since the distance from the hole to the surface of the substrate is more than 0 and 2000 nm or less, in a case where the electrolysis is performed by the resultant electrode, the electrons can move in the electrode via the impurity level in the surface layer positioned from the holes to the substrate surface or owing to the Fowler-Nordheim tunnel. Accordingly, in the electrode reaction in the anode, the empty level in the vicinity of the bottom of the conduction band has the energy level which is higher than the Fermi level as much as about the half of the band gap, can receive the electrons from the electrolyte, and excites the movement of the electrons at the higher energy level. Accordingly, ozone can efficiently be generated at the lower current density.

### BRIEF DESCRIPTION OF THE DRAWINGS

FIG. 1 is a plan view of an ozone generating electrode of the present invention;

FIG. 2 is a schematic enlarged sectional view cut along the A-A line of FIG. 1;

FIG. 3 is a schematic enlarged sectional view cut along the A-A line of FIG. 1 in another embodiment;

FIG. 4 is a flow chart of a method of manufacturing the ozone generating electrode of the present invention;

FIG. 5 is an SEM picture diagram of the ozone generating electrode;

FIG. 6 is a TEM picture diagram of the ozone generating electrode;

FIG. 7 is a schematic diagram of an ozone water generation device;

FIG. 8 is a diagram showing an amount of ozone to be generated for each content ratio of tantalum contained in the surface layer of an electrode for electrolysis of an embodiment in the ozone water generation device of FIG. 7; and

FIG. 9 is a diagram showing an amount of ozone to be generated in an ozone generating electrode in another embodiment.

### DETAILED DESCRIPTION OF THE PREFERRED EMBODIMENTS

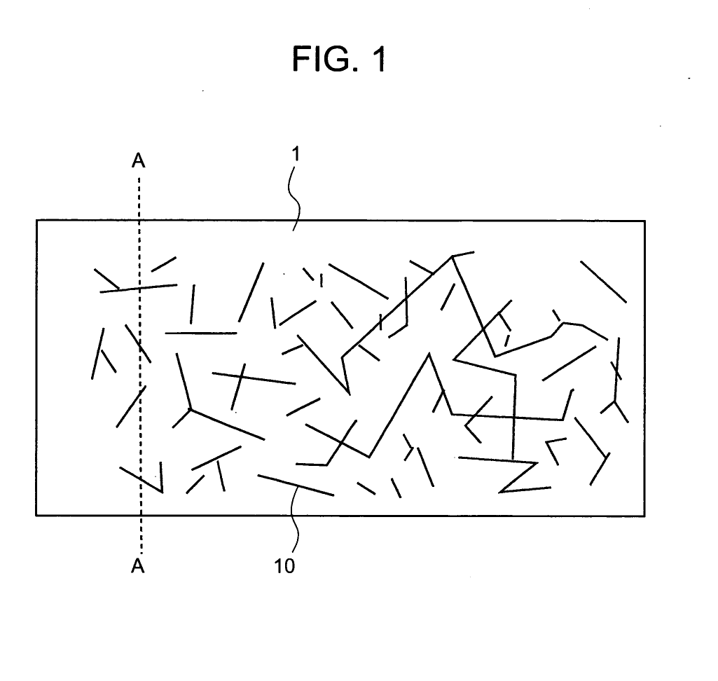

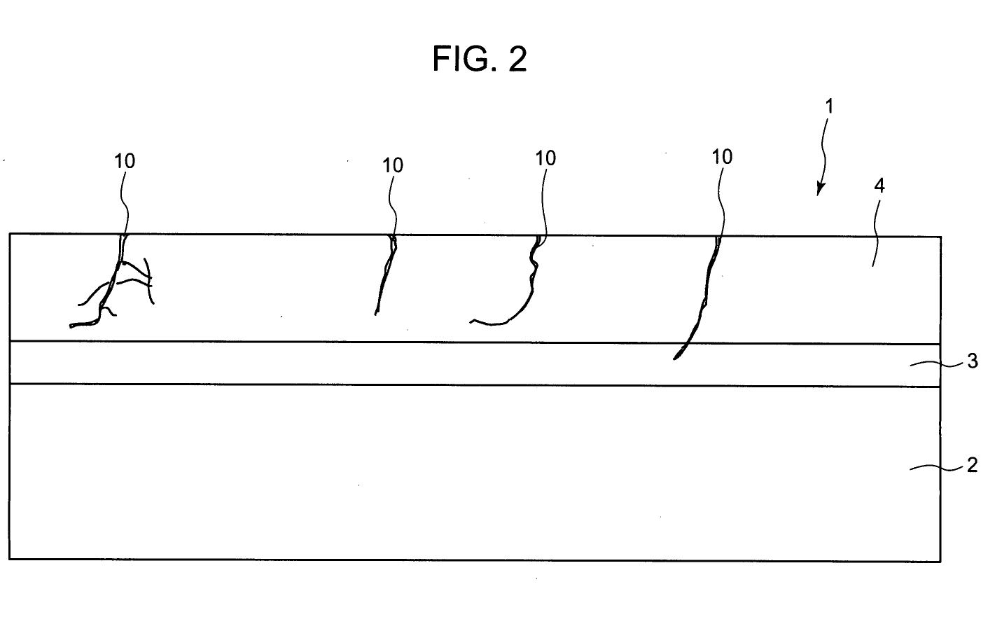

There will be described hereinafter preferable embodiments of an electrode for electrolysis of the present invention with reference to the drawings. FIG. 1 is a plan view of an ozone generating electrode 1 as one example of the electrode for electrolysis in the present invention, and FIG. 2 is a schematic enlarged sectional view cut along the A-A line of FIG. 1.

As shown in FIG. 1, the ozone generating electrode 1 is constituted of: a substrate 2; an intermediate layer 3 formed on the surface of the substrate 2; and a surface layer 4 formed on the surface of the intermediate layer 3.

In the present invention, the substrate 2 is made of, as a conductive material, a valve metal such as titanium (Ti), tantalum (Ta), zirconium (Zr) or niobium (Nb), an alloy of two or more of these valve metals, silicon (Si) or the like. In a case where cost, workability, resistance to corrosion and the like are considered, titanium is preferably used.

The intermediate layer 3 is made of, as a metal which is difficult to oxidize, a metal oxide having a conductivity even when oxidized or a metal having the conductivity even when oxidized: a platinum group element such as platinum, ruthenium (Ru), rhodium (Rh), palladium (Pd), iridium (Ir), gold (Au) or silver (Ag); a noble metal oxide such as iridium oxide, palladium oxide or ruthenium oxide; an oxide superconductor or the like In the present embodiment, it is assumed that the intermediate layer 3 is made of platinum. It is to be noted that in a case where the substrate 2 is made of platinum, the surface of the substrate 2 is, needless to say, made of platinum. Therefore, the intermediate layer 3 does not have to be especially constituted. However, in a case where the substrate 2 is made of platinum, a cost rise is incurred. Therefore, it is industrially preferable that the substrate 2 is constituted of an inexpensive material, and the intermediate layer 3 made of a noble metal or the like is formed on the surface of the substrate 2.

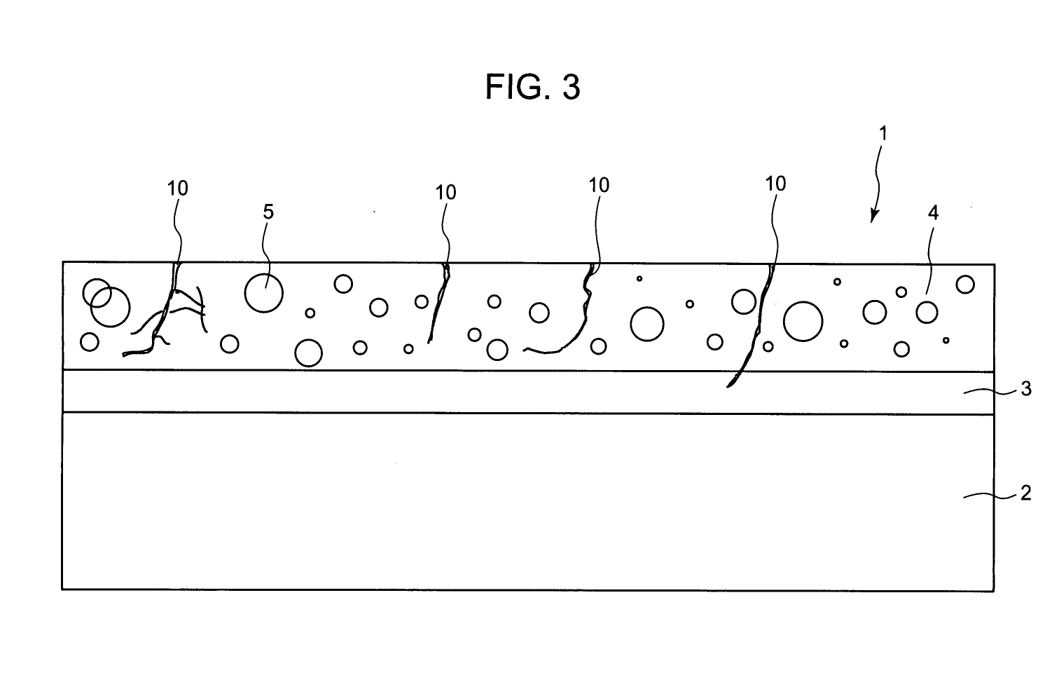

Moreover, the surface layer 4 is constituted of a dielectric material into a layer on the surface of the substrate 2 together with the intermediate layer 3 so as to coat the intermediate layer 3. As the dielectric material constituting the surface layer 4, there is used tantalum oxide, aluminum oxide, titanium oxide, tungsten oxide, niobium oxide or the like. It is to be noted that as shown in FIG. 2, the surface layer 4 in the ozone generating electrode 1 of the present invention may be constituted of the dielectric material, but as shown in FIG. 3, besides the dielectric material, the surface layer may contain a noble metal such as platinum 5 which is similar to that for use in the intermediate layer 3 or a noble metal oxide.

Moreover, the surface layer 4 may be made of: an oxide containing two or more types of metal elements represented by a perovskite oxide such as barium titanate (BaTiO₃); or a mixture of two or more types of oxides having different crystal structures, such as a mixture of titanium oxide and tantalum oxide. Even in this case, instead of such oxide, there may be used the layer containing the above noble metal or the noble-metal oxide.

Here, tantalum oxide indicates a general substance constituted by combining tantalum with oxygen, and examples of tantalum oxide include: crystalline TaO or Ta₂O₅; such an oxide in which a slight oxygen defect is generated, such as TaO₁₋ₓ or Ta₂O₅₋ₓ; and amorphous TaOₓ. Examples of aluminum oxide include Al₂O₃ and AlOₓ. Examples of titanium oxide include TiO₂, Ti₂O₃ and TiOₓ. Examples of tungsten oxide include WO₃ and WOₓ. It is to be noted that as another dielectric material forming the surface layer 4, there is applicable Na₂O, NaOₓ, MgO, MgOₓ, SiO₂, SiOₓ, K₂O, KOₓ, CaO, CaOₓ, Sc₂O₃, ScOₓ, V₂O₅, VOₓ, CrO₂, CrOₓ, Mn₃O₄, MnOₓ, Fe₂O₃, FeOₓ, CoO, CoOₓ, NiO, NiOₓ, CuO, CuOₓ, ZnO, ZnOₓ, GaO, GaOₓ, GeO₂, GeOₓ, Rb₂O₃, RbOₓ, SrO, SrOₓ, Y₂O₃, YOₓ, ZrO₂, ZrOₓ, Nb₂O₅, NbOₓ, MoO₃, MoOₓ, In₂O₃, InOₓ, SnO₂, SnOₓ, Sb₂O₅, SbOₓ, Cs₂O₅, CsOₓ, BaO, BaOₓ, La₂O₃, LaOₓ, CeO₂, CeOₓ, PrO₂, PrOₓ, Nd₂O₃, NdOₓ, Pm₂O₃, PmOₓ, Sm₂O₃, SmOₓ, Eu₂O₃, EuOₓ, Gd₂O₃, GdOₓ, Tb₂O₃, TbOₓ, Dy₂O₃, DyOₓ, Ho₂O₃, HoOₓ, Er₂O₃, ErOₓ, Tm₂O₃, TmOₓ, Yb₂O₃, YbOₓ, Lu₂O₃, LuOₓ, HfO₂, HfOₓ, PbO₂, PbOₓ, Bi₂O₃, BiOₓ or the like.

### EMBODIMENT 1

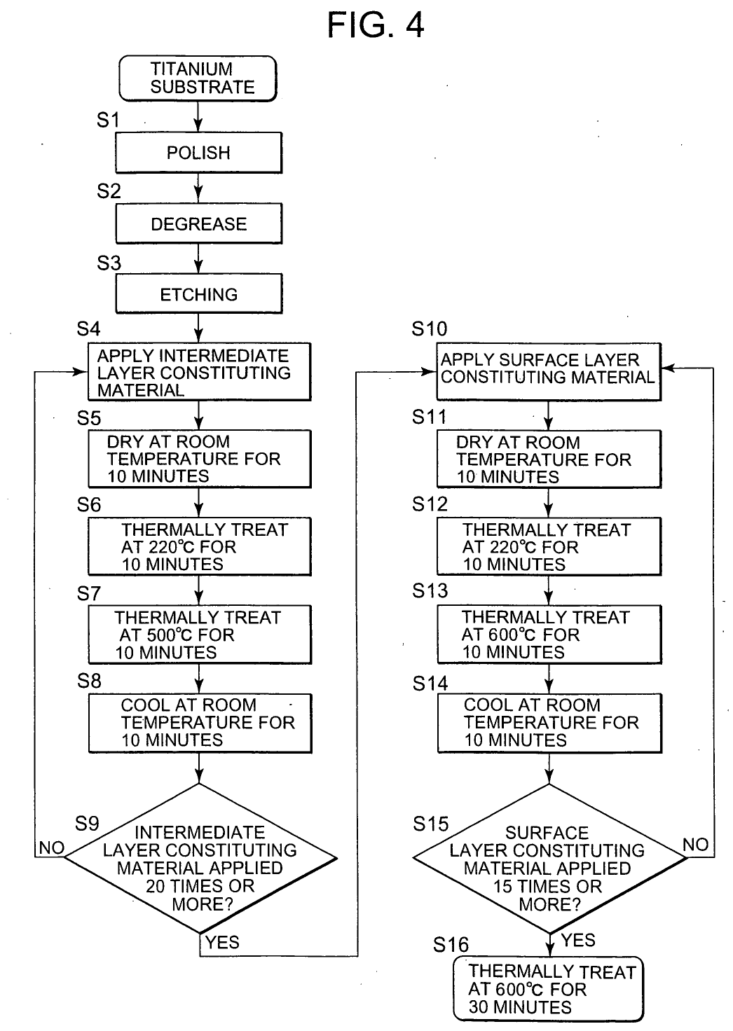

Next, there will be described a method of manufacturing an electrode for electrolysis with reference to a flow chart of FIG. 4. In this manufacturing method, the surface of a conductive substrate 2 is coated with an intermediate layer 3, and the surface of this intermediate layer 3 is coated with a surface layer 4.

First, a titanium plate having a thickness of 1 mm, a length of 80 mm and a width of 20 mm is used as the conductive substrate 2, and the surface (surface having a length of 80 mm and a width of 20 mm) of this conductive substrate 2 is polished by a sandpaper (step S1). It is to be noted that in an ozone generating electrode 1 of the present embodiment, the surface of the conductive substrate 2 is coated with the intermediate layer 3 and the surface layer 4 on only one side, and this surface layer 4 is opposed to a counter electrode, and used as a reactive surface of electrolysis. In a case where the ozone generating electrode 1 of the present invention is used in, for example, a bipolar electrolysis device or the like, the intermediate layer 3 and the surface layer 4 may be formed on opposite surfaces of the conductive substrate 2 or all surfaces of the conductive substrate 2. In this case, it is assumed that the opposite surfaces or all the surfaces of the conductive substrate 2 are subjected to manufacturing steps such as the polishing of the surface of the conductive substrate 2, and etching, thermal treatment and the like described later.

Moreover, there is not any special restriction on the polishing of the surface of the conductive substrate 2 as long as an oxide film formed on the surface of the conductive substrate 2 can be removed, and not only the method using the sandpaper but also another method such as sand blasting may be used as long as a similar effect is obtained.

Next, the conductive substrate 2 having the surface thereof polished is decreased with an organic solvent such as acetone in the present embodiment (step S2). Thereafter, in the present embodiment, the etching is executed by a thermal aqueous oxalic acid solution having a concentration of 200 g/l for three hours until a predetermined surface roughness is obtained (step S3). It is to be noted that instead of the thermal aqueous oxalic acid solution, for example, thermal sulfuric acid, hydrofluoric acid or the like may be used.

On the conductive substrate 2 having the surface thereof roughened by the etching, first the intermediate layer 3 is formed. In the ozone generating electrode 1 of the present embodiment, to form the intermediate layer 3 of platinum, in a solvent prepared so that a mixture ratio between isopropyl alcohol and ethylene glycol monoethyl ether is 4:1, hexachloro palatinate hexahydrate is dissolved in such an amount as to obtain a platinum concentration of 50 g/l, thereby forming an intermediate layer constituting material.

Moreover, to the surface of the conductive substrate 2, the intermediate layer constituting material is uniformly applied by use of a spatula (not shown) (step S4). It is to be noted that as a method of applying the intermediate layer constituting material, besides the method of applying the material by use of the spatula as described above, there may be performed: a method of applying the intermediate layer constituting material onto the conductive substrate 2 with a spray (not shown); a method of storing the intermediate layer constituting material in a container (not shown) to submerge the conductive substrate 2 in this container; a method (spin coating) of rotating the conductive substrate 2 to apply the intermediate layer constituting material to the substrate by a centrifugal force or the like.

Next, the conductive substrate 2 constituted by attaching the intermediate layer constituting material to the surface of the conductive substrate 2 is dried at room temperature for ten minutes (step S5). Thereafter, a thermal treatment is performed in a temperature range of +150° C. to +250° C., at preferably +220° C. for ten minutes (step S6). Furthermore, the thermal treatment is performed in a temperature range of +400° C. to +550° C., at preferably +500° C. for ten minutes (step S7). Accordingly, the solvent component and the like are evaporated, and the intermediate layer 3 made of platinum is formed on the surface of the conductive substrate 2.

Moreover, the conductive substrate 2 on which the intermediate layer 3 has been formed is cooled at room temperature for ten minutes (step S8). Thereafter, as shown in FIG. 4, the intermediate layer constituting material is applied again (step S4), the substrate is dried at room temperature (step S5), the substrate is thermally treated at 220° C. (step S6), the substrate is thermally treated at +500° C. (step S7), and the substrate is cooled at room temperature (step S8). These steps are repeated until a thickness of the intermediate layer 3 reaches a predetermined thickness (step S9). It is to be noted that in the ozone generating electrode 1 of the present embodiment, the above steps are repeatedly performed 20 times so that the thickness of the intermediate layer 3 is about 100 nm on average.

When the steps of preparing the intermediate layer 3 are repeated a plurality of times in this manner, as compared with a case where a large amount of the intermediate layer constituting material is constituted on the surface of the conductive substrate 2 at once, the conductive substrate 2 can be coated with an appropriate amount of platinum having an appropriate thickness with a good in-plane homogeneity. It is also possible to form the intermediate layer 3 having a high close contact property, and durability of the electrode can be enhanced. Since the thickness of the intermediate layer 3 can easily be obtained in accordance with the durability necessary for the electrode, a use amount of the noble metal or the noble metal oxide can be set to be appropriate, and wasteful use of the noble metal and the noble metal oxide can be reduced.

Thereafter, on the surface of the intermediate layer 3 formed on the surface of the conductive substrate 2, the surface layer 4 constituted of a dielectric material is formed. In the ozone generating electrode 1 of the present embodiment, to form the surface layer 4 of tantalum oxide as the dielectric material, in a solvent prepared so that a mixture ratio between n-butyl acetate and dimethyl formamide is 95:5, tantalum ethoxide is dissolved in such an amount as to obtain a tantalum concentration of 1.45 mol/l, thereby forming a surface layer constituting material.

It is to be noted that as described above, besides the dielectric material, the surface layer 4 may contain the noble metal or the noble metal oxide for use in the intermediate layer 3. In this case, when, for example, platinum is used as the noble metal, in a solvent prepared so that a mixture ratio between isopropyl alcohol and ethylene glycol monoethyl ether is 4:1 as described above, hexachloro palatinate hexahydrate and tantalum ethoxide similar to those used in the intermediate layer constituting material are dissolved so that a total concentration of platinum and tantalum is 1.45 mol/l. It is preferable for the ozone generating electrode to set a mixture ratio between platinum and tantalum so that, as described later, in a constituting ratio between tantalum oxide and platinum in the surface layer 4, a content ratio of tantalum is 75 mol % or more, and a balance is platinum. It is to be noted that in addition to tantalum and platinum described above, the surface layer 4 contains oxygen. In the following description of the present invention, it is assumed that the content ratio of tantalum is a ratio (mol %) occupied by tantalum with respect to the total amount of tantalum and platinum in the surface layer 4 excluding oxygen.

Moreover, in the same manner as in the method of applying the intermediate layer constituting material for forming the intermediate layer 3, the surface layer constituting material is applied using a spatula, and the surface layer constituting material is uniformly applied to the surface of the intermediate layer 3 formed on the surface of the conductive substrate 2 (step S10). It is to be noted that even during the application of this surface layer constituting material, in the same manner as in a case where the intermediate layer constituting material is applied, besides the method of applying the material by use of the spatula, there may be performed: a method of applying the surface layer constituting material with a spray (not shown); a method of storing the surface layer constituting material in a container (not shown) to submerge the conductive substrate 2 in this container; a method of rotating the conductive substrate 2 to apply the surface layer constituting material to the substrate by the centrifugal force or the like.

On the conductive substrate 2 constituted by attaching the surface layer constituting material to the surface of the intermediate layer 3 in this manner, the surface layer 4 is formed by a preparing step substantially similar to the preparing step for forming the intermediate layer 3.

That is, the conductive substrate 2 in which the surface layer constituting material has been attached to the surface of the intermediate layer 3 is dried at room temperature for ten minutes (step S11). Thereafter, a thermal treatment is performed in a temperature range of +150° C. to +250° C., at preferably +220° C. for ten minutes (step S12). Furthermore, during the preparation of this surface layer 4, next the thermal treatment is performed in a temperature range of +600° C. to +700° C., at preferably +600° C. which is higher than the temperature of the thermal treatment of the intermediate layer 3 for ten minutes (step S13). Accordingly, further on the surface of the intermediate layer 3 formed on the surface of the conductive substrate 2, the surface layer 4 is formed which is made of tantalum oxide, or tantalum oxide and platinum.

Moreover, the conductive substrate 2 on which the surface layer 4 has been formed is cooled at room temperature for ten minutes (step S14). Thereafter, as shown in FIG. 4, the surface layer constituting material is applied again, the substrate is dried at room temperature, the substrate is thermally treated at 220° C., the substrate is thermally treated at +600° C., and the substrate is cooled at room temperature. These steps are repeated until a thickness of the surface layer 4 reaches a predetermined thickness (step S15). It is to be noted that in the ozone generating electrode 1 of the present embodiment, the above steps are performed 25 times so that the thickness of the surface layer 4 reaches a predetermined thickness. In consequence, the ozone generating electrode 1 of the present invention is prepared.

It is to be noted that in the present embodiment, during the thermal treatment of the surface layer 4 performed at 600° C., it is assumed that a time required for the last twenty five thermal treatment is 30 minutes (step S16). In consequence, it is possible to prevent remaining of the solvent on the surface of the prepared ozone generating electrode 1, inadequacy of the thermal treatment of the intermediate layer 3 and the surface layer 4, thermal treatment unevenness and the like.

Moreover, in the ozone generating electrode 1, when the steps of preparing the surface layer 4 are repeated a plurality of times as described above, in the same manner as in the step of preparing the intermediate layer 3, as compared with a case where a large amount of the surface layer constituting material is constituted on the surface of the intermediate layer 3 at once, the surface of the intermediate layer 3 can be coated with an appropriate amount of tantalum having an appropriate thickness with the good in-plane homogeneity. It is also possible to form the surface layer 4 having the high close contact property, and the durability of the electrode can further be enhanced.

Furthermore, in the method of manufacturing the ozone generating electrode 1 in the present embodiment, since the thermal treatment temperature (+600° C.) of the surface layer 4 can be set to be higher than the thermal treatment temperature (+500° C.) of the intermediate layer 3 to crystallize tantalum oxide constituting the surface layer 4. When tantalum oxide is crystallized in this manner, an inner stress in the surface layer 4 enlarges, holes 10, so-called cracks are formed in the surface layer 4. It is to be noted that since the surface layer 4 is repeatedly applied and formed onto the surface of the intermediate layer 3 a plurality of times as described above, the holes 10 are constituted while a large number of cracks complicatedly repeat branching and combining in the surface layer 4.

Moreover, in the ozone generating electrode 1 of the present embodiment, the intermediate layer 3 is constituted by applying the intermediate layer constituting material a plurality of times as described above, and the intermediate layer 3 and the surface layer 4 are formed at the thermal treatment temperature as described above. Some of the holes 10 extend through the surface layer 4 to reach an interface between the surface layer and the intermediate layer 3, but do not reach the conductive substrate 2, and it is possible to avoid a disadvantage that the conductive substrate 2 is corroded during the electrolysis.

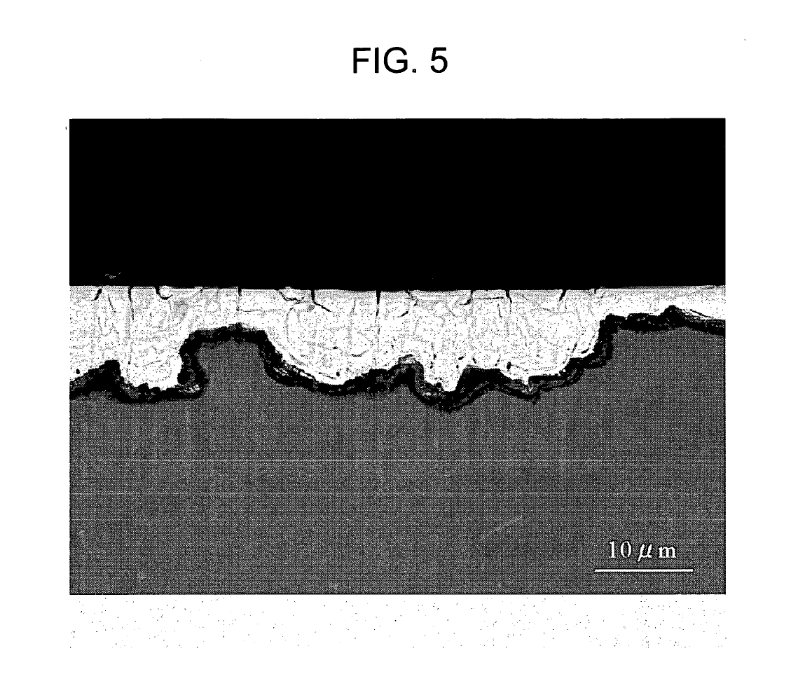

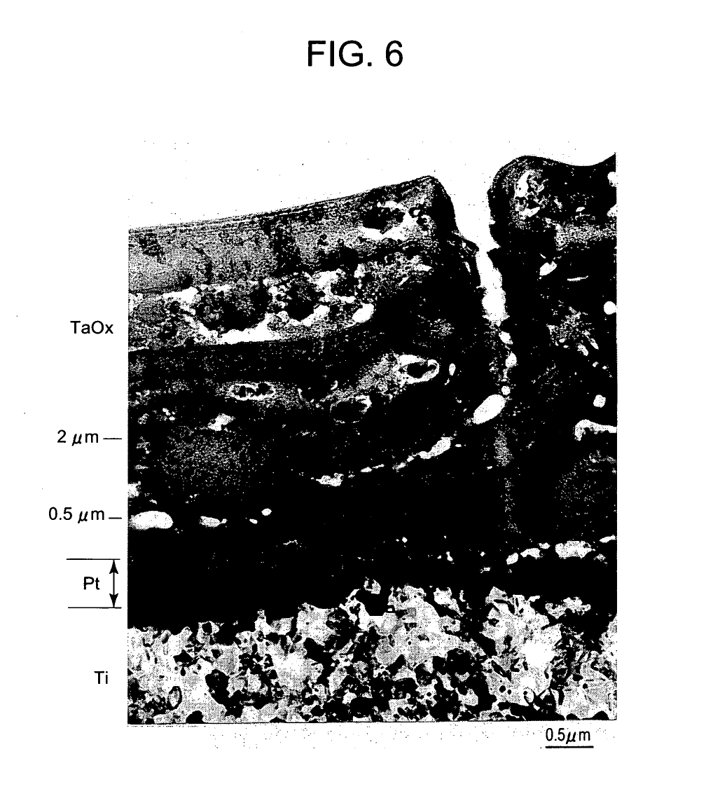

Especially among the holes 10, as shown by the second hole from the right in FIG. 2, there is the hole 10 one end of which formed on the surface layer 4 does not reach the intermediate layer 3, and a distance from the intermediate layer 3 to one end of the hole 10, that is, a position closest to the intermediate layer 3 is more than 0 and 2000 nm or less. It is to be noted that FIG. 5 is an SEM picture of the ozone generating electrode 1, and FIG. 6 is a TEM picture in which the hole 10 is noted.

In the SEM picture of FIG. 5, a layer shown in white is the surface layer 4 in the present invention, and a layer which is formed to come into contact with the underside of the surface layer 4 and which is shown in dark gray is the intermediate layer 3. Furthermore, a layer which is formed to come into contact with the underside of the intermediate layer 3 and which is shown in light gray is the substrate 2. It is seen from this picture that a plurality of cracks or holes 10 are formed in the surface layer 4. All the holes 10 do not have uniform depths or shapes, but the hole having its end portion on the side of the intermediate layer 3 does not extend through the surface layer 4 or the intermediate layer 3, and does not reach the conductive substrate 2 as described above.

Especially, the hole 10 noted in the present invention has one end that does not reach the intermediate layer 3, and the distance from one end of the hole to the intermediate layer 3 is more than 0 and 2000 nm or less. This hole will be described with reference to the TEM picture of FIG. 6.

The hole 10 shown herein has a hole diameter of about 0.67 μm in the topmost surface, and a section of the hole 10 is shown in a substantial L-shape. Since FIG. 6 is a sectional view, it is difficult to grasp the whole shape of the hole 10, but the hole 10 formed as the crack is constituted by complicatedly repeating a large number of branches and combinations. Therefore, if even the hole that seems to be discontinuous is viewed from another angle, the hole 10 is continuously formed, and inwardly continuously extends from the surface of the surface layer 4. One end of this hole 10 on the side of the intermediate layer 3 is formed in a position having a distance of about 0.5 μm from the intermediate layer 3.

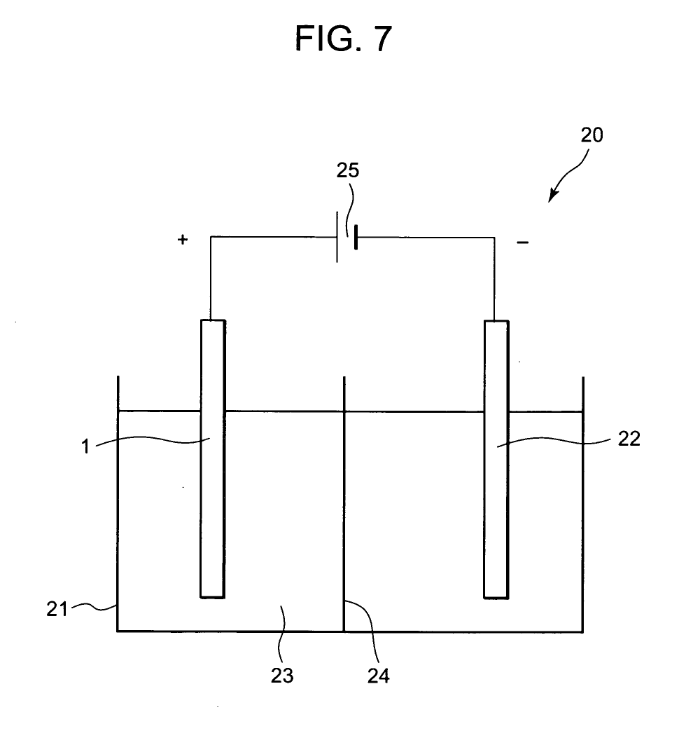

Next, there will be described ozone generation by electrolysis using the ozone generating electrode 1 manufactured in the above embodiment with reference to FIG. 7. FIG. 7 is a schematic explanatory view of an ozone water generating device 20 to which the ozone generating electrode 1 of the present embodiment has been applied. The ozone water generating device 20 includes: a treatment tank 21; the above-described ozone generating electrode 1 as an anode; an electrode 22 as a cathode; a cation exchange film 24; and a power supply 25 which applies a direct current to the electrodes 1 and 22. In this treatment tank 21, model tap water 23 is pooled as an electrolytic solution.

The ozone generating electrode 1 is prepared by the above manufacturing method. As the ozone generating electrode 1 for use in the ozone water generating device 20, there are used electrodes having 15 types of tantalum content ratios in the surface layers 4 in total: 0 mol %; 10 mol %; 20 mol %; 30 mol %; 40 mol %; 50 mol %; 60 mol %; 70 mol %; 75 mol %; 80 mol %; 85 mol %; 90 mol %; 95 mol %; 99 mol %; and 100 mol %. There were measured amounts of ozone to be generated in a case where these ozone generating electrodes 1 are used as the anodes, respectively, and the 15 types of the ozone generating electrodes 1 were evaluated. It is to be noted that in each of the 15 types of ozone generating electrodes 1, a portion other than tantalum oxide in the surface layer 4 is made of platinum and oxygen as described above.

On the other hand, platinum is used in the electrode 22 as a cathode. In addition, there may be constituted: an insoluble electrode obtained by sintering platinum on the surface of the titanium substrate; a platinum-iridium based electrode for electrolysis; a carbon electrode or the like.

The cation exchange film 24 is a fluororesin-based film having durability against an oxidizing agent such as hydrogen peroxide. As a typical cation exchange film, there is a perfluoro sulfonic acid-based film such as trade name Nafion 115, 117, 315 or 350 manufactured by DuPont. It is assumed that in the present embodiment, Nafion is used as the cation exchange film 24.

Moreover, in the present embodiment, the electrolytic solution to be electrolyzed is an aqueous solution obtained by simulating tap water. A component composition of the model tap water 23 is: 5.75 ppm of Na⁺; 10.02 ppm of Ca²⁺; 6.08 ppm of Mg²⁺; 0.98 ppm of K⁺; 17.75 ppm of Cl⁻; 24.5 ppm of SO₄² ; and 16.5 ppm of CO₃²⁻.

According to the above constitution, 300 ml in total of the model tap water 23 at water temperature of +15° C. is stored in the treatment tank 21: 150 ml of water is stored in each of an anode side and a cathode side defined by the cation exchange film 24 in the treatment tank. The ozone generating electrode 1 and the electrode 22 are submerged in the model tap water on the anode side and that on the cathode side, respectively, with the cation exchange film 24 being sandwiched between the opposite sides. It is to be noted that in the present embodiment, each of areas of the ozone generating electrode 1 and the electrode 22 is 80 mm×20 mm (submerged portion of 40 mm×20 mm), and a distance between the electrodes is set to 10 mm. Furthermore, the power supply 25 applies each constant current of 150 mA to the ozone generating electrode 1 and the electrode 22 at a current density of 18.8 mA/cm².

It is to be noted that in the present embodiment, the amount of ozone to be generated by the ozone generating electrode 1 is obtained by measuring, by a calorimetric method, a concentration of ozone in the model tap water 23 after the electrolysis performed for one minute on the above conditions.

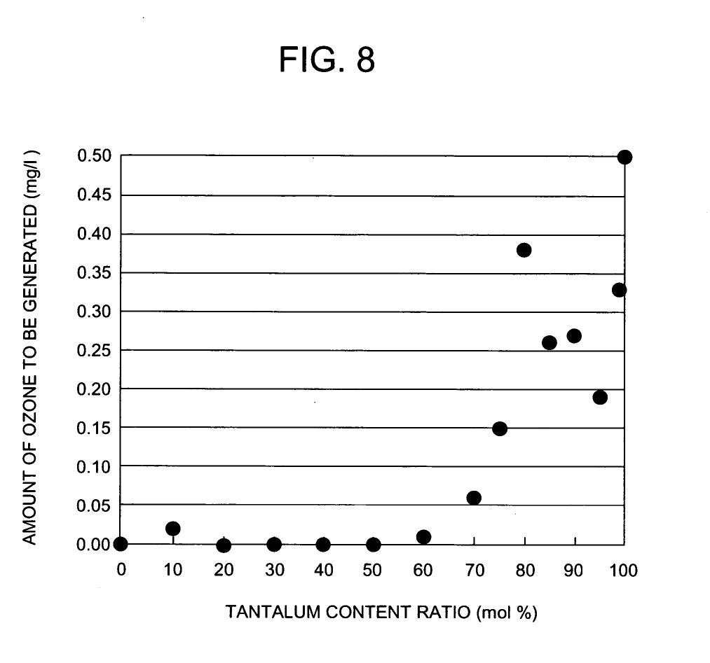

Next, there will be described the amount of ozone to be generated with respect to the content ratio of tantalum oxide in the surface layer 4 of the ozone generating electrode 1 in the present embodiment with reference to FIG. 8. FIG. 8 shows the amount of ozone to be generated by each ozone generating electrode 1 on the same conditions among the 15 types of ozone generating electrodes in the present embodiment. In FIG. 8, the ordinate indicates the amount of ozone to be generated (mg/l), and the abscissa indicates the content ratio of tantalum in the surface layer 4 of the ozone generating electrode 1.

As seen from FIG. 8, in a case where the content ratio of tantalum in the surface layer 4 of the ozone generating electrode 1 was less than 70 mol %, the amount of ozone to be generated was very small. When the content ratio of tantalum was 70 mol % or more, the amount of ozone to be generated rapidly increased. Experimental results indicated that the amount of ozone to be generated was: 0.38 mg/l at the content ratio of 70 mol %; 0.15 mg/l at the content ratio of 75 mol %; 0.38 mg/l at the content ratio of 80 mol %; 0.26 mg/l at the content ratio of 85 mol %; 0.27 mg/l at the content ratio of 90 mol %; 0.19 mg/l at the content ratio of 95 mol %; 0.33 mg/l at the content ratio of 99 mol %; and 0.50 mg/l at the content ratio of 100 mol %. It is to be noted that in a case where the content ratio was 0 mol %, that is, the surface layer 4 of the ozone generating electrode 1 was all made of platinum, the ozone generation was not recognized on the conditions of the present embodiment.

As described above, when the content ratio of tantalum is 80 mol % or more, the amount of ozone to be generated tends to be substantially saturated, but when the content ratio is 100 mol %, the largest amount of ozone to be generated is indicated.

Moreover, when in the surface layer 4 of the ozone generating electrode 1, the content ratio of tantalum constituting the dielectric material is 70 mol % or more, especially 80 mol %, the amount of ozone to be generated is large. Especially, when the content ratio is 100 mol %, the largest amount of ozone to be generated is indicated. Therefore, it is seen that tantalum oxide in the surface layer 4 of the ozone generating electrode 1 in the present embodiment largely influences the ozone generation, and increases the amount of ozone to be generated.

It is to be noted that usually in a case where all the electrode surface is coated with the dielectric material only as in a case where the content ratio of tantalum in the present embodiment is 100 mol %, the conductivity of the electrode is not obtained. However, the distance from the hole 10 formed in the surface layer 4 made of tantalum oxide to the intermediate layer 3 is, for example, about 0.5 μm, and comparatively short as described above. Therefore, it is supposed that when electrons move to the intermediate layer 3 constituted of the conductive material via an impurity level of the surface layer 4, or owing to the Fowler-Nordheim tunnel, the conductivity of the electrode is obtained.

Usually in a case where the metal electrode is used as the ozone generating electrode, the electrode reaction in the anode is excited, when the empty level directly above the Fermi level receives the electrons from the electrolyte. On the other hand, in a case where the ozone generating electrode 1 including the surface layer 4 is used in which the holes 10 are formed to have predetermined distances to the intermediate layer 3 as in the present invention, the reaction is excited, when the empty level in the vicinity of the bottom of the conduction band receives the electrons from the electrolyte, the conduction band being brought into an energy level which is higher as much as about a half of a band gap than the Fermi level.

Therefore, in a case where the ozone generating electrode 1 of the present invention is used, as compared with a case where the platinum electrode is used, the movement of the electrons in a higher energy level is caused to excite the electrode reaction. Therefore, it is considered that the ozone generating efficiency rises.

In consequence, there can be obtained the electrode capable of generating ozone at a high efficiency even with a low current density, in a case where the distance from the hole 10 to the surface of the intermediate layer 3 in the ozone generating electrode 1 is more than 0 and 2000 nm or less.

Moreover, in the ozone generating electrode 1 of the present embodiment, in addition to the hole 10 having the above depth dimension, there is also formed the hole 10 which reaches the intermediate layer 3. Therefore, this hole 10 is a path of a current, and the currents flows via the intermediate layer 3 formed under the surface layer 4 and made of the noble metal or the noble metal oxide. The hole also functions as the electrode.

Moreover, in such an ozone generating electrode 1, the electrons are transmitted and received in a small area of a surface portion of the intermediate layer 3 which communicates with the hole 10 via the hole 10 constituting the path of the current in the surface layer 4 described above. Therefore, it is considered that there is a rise in current density of platinum of the portion of the intermediate layer 3 which communicates with the hole 10, and the amount of ozone to be generated is large even with a small input current owing to a catalytic function of tantalum oxide around the hole 10 of the surface layer 4.

It is to be noted that as the solvents used in the intermediate layer constituting material and the surface layer constituting material described in the method of manufacturing the ozone generating electrode 1 of the present embodiment, there are used: the solvent prepared so that the mixture ratio between isopropyl alcohol and ethylene glycol monoethyl ether is 4:1; and the solvent prepared so that so that the mixture ratio between n-butyl acetate and dimethyl formamide is 95:5, respectively. However, there is not any restriction on the solvent as long as the solvent is capable of dissolving hexachloro palatinate hexahydrate and tantalum ethoxide for constituting the intermediate layer 3 and the surface layer 4. Furthermore, there is not any restriction on hexachloro palatinate hexahydrate and tantalum ethoxide as long as the ozone generating electrode 1 of the present invention can be constituted. A use amount of the solvent can be increased or decreased if necessary.

Furthermore, in the present embodiment, since the substrate 2 is made of titanium, the distance from the hole 10 formed in the surface layer 4 to the intermediate layer 3 is more than 0 and 2000 nm or less. For example, in a case where the substrate 2 is constituted of a material similar to that of the intermediate layer 3, such as platinum or the like, however, the intermediate layer 3 does not have to be especially constituted. In such a case, when the distance from the hole 10 formed in the surface layer 4 to the substrate 2 is more than 0 and 2000 nm or less, an effect similar to that of the present embodiment is obtained.

### EMBODIMENT 2

Next, another embodiment of the present invention will be described. An ozone generating electrode 1 of the present embodiment is different from that of Embodiment 1 in that instead of tantalum oxide in the surface layer 4 of Embodiment 1, aluminum oxide, titanium oxide or tungsten oxide is used.

It is to be noted that in Embodiment 1, to form the surface layer 4 of tantalum oxide, to the solvent prepared so that the mixture ratio between n-butyl acetate and dimethyl formamide is 95:5, tantalum ethoxide is dissolved in such an amount as to obtain the tantalum concentration of 1.45 mol/l, thereby forming the surface layer constituting material. On the other hand, in the present embodiment, in a case where a surface layer 4 is made of aluminum oxide, isoamyl acetate is used as a solvent, and in this solvent, an organic metal including aluminum (Al) is dissolved to obtain a surface constituting material. In a case where the surface layer 4 is made of titanium oxide, n-butyl acetate is used as the solvent, and in this solvent, an organic metal including titanium (Ti) is dissolved to obtain the surface constituting material. Furthermore, in a case where the surface layer 4 is made of tungsten oxide (W), a mixture of xylene and n-butyl acetate is used as the solvent, and in this solvent, an organic metal including W is dissolved to obtain the surface constituting material.

Moreover, in the method of manufacturing the ozone generating electrode 1 in Embodiment 1, the conductive substrate 2 constituted by attaching the surface layer constituting material to the surface of the intermediate layer 3 is dried at room temperature for ten minutes, thereafter thermally treated at +220° C. for ten minutes, and next thermally treated at +600° C. for ten minutes. Furthermore, these steps are repeatedly performed 25 times. On the other hand, in the present embodiment, a conductive substrate 2 constituted by attaching the surface layer constituting material to the surface of an intermediate layer 3 is dried at room temperature for ten minutes, thereafter thermally treated at +220° C. for ten minutes, and next thermally treated at +600° C. or +650° C. for ten minutes (hereinafter referred to as the surface layer thermal treatment). These steps are repeatedly performed 20 times.

Next, there will be described ozone generation by electrolysis using the ozone generating electrode 1 of the present embodiment. Even in this case, the description of the ozone generation of the present embodiment is similar to that of Embodiment 1 except that the ozone generating electrode 1 is different.

In the present embodiment, as the ozone generating electrodes 1, three types of conductive substrates 2 constituted by attaching the surface layer constituting materials to the surfaces of the intermediate layers 3 were subjected to the surface layer thermal treatment at +600° C. or +650° C., and the electrodes were evaluated. It is to be noted that in the surface layer 4 of the ozone generating electrode 1 of the present embodiment, a content ratio of aluminum oxide, titanium oxide or tungsten oxide is 100 mol %.

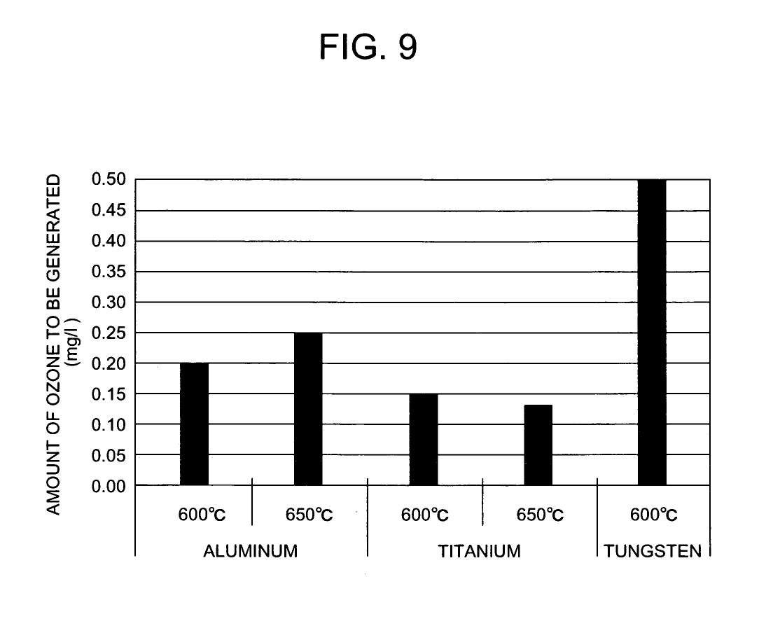

FIG. 9 shows an amount of ozone to be generated by each ozone generating electrode 1 in the present embodiment. FIG. 9 shows the amounts of ozone to be generated by the three types (as the surface layers 4, aluminum oxide, titanium oxide and tungsten oxide) of ozone generating electrodes 1 in the present embodiment on the same conditions, respectively: aluminum oxide and titanium oxide are used and the temperatures of the surface layer thermal treatment are +600° C. and +650° C.; tungsten oxide is used and the temperature of the surface layer thermal treatment is +600° C.

As seen from FIG. 9, in a case where aluminum oxide was used as the surface layer 4, the amount of ozone to be generated indicated 0.20 mg/l at the surface layer thermal treatment temperature of +600° C., and 0.25 mg/l at +650° C. In a case where titanium oxide was used as the surface layer 4, the amount of ozone to be generated indicated 0.15 mg/l at the surface layer thermal treatment temperature of +600° C., and 0.13 mg/l at +650° C. Furthermore, in a case where tungsten oxide was used as the surface layer 4, the amount of ozone to be generated indicated 0.50 mg/l at the surface layer thermal treatment temperature of +600° C.

Furthermore, in the present embodiment in the same manner as in Embodiment 1, there is not any restriction on the solvents for use in the intermediate layer constituting material and the surface layer constituting material, and Al, Ti and W to be dissolved in the solvent as long as the ozone generating electrode 1 of the present invention can be constituted.

As described above in detail, when the ozone generating electrode 1 of the present invention electrolyzes simulated tap water, ozone can be generated without especially raising a current value. Therefore, the ozone generation can easily be performed by the electrolysis, and ozone water can easily be generated.

Moreover, in the above embodiments, the above insoluble electrode is used as the cathode, but the ozone generating electrode 1 of the present invention may be used in the cathode. In this case, both of the poles are constituted of the ozone generating electrodes 1. Therefore, polarities of the anode and the cathode may be switched. When the polarity is switched in this manner, pollutant substances and the like attached to each electrode surface are peeled to refresh the electrode surface. Therefore, the ozone generation efficiency can further be enhanced.

It is to be noted that the holes 10 formed in the surface layer 4 of the ozone generating electrode 1 in each embodiment are formed as the cracks by the thermal treatment during the preparation of the ozone generating electrode 1 in each embodiment, but the present invention is not limited to this embodiment, and the holes may physically be worked using, for example, a machine or the like.

What is claimed is:

1. An electrode for electrolysis comprising a substrate, and a surface layer formed on the surface of the substrate and including a dielectric material,
wherein the surface layer includes holes which inwardly continuously extend from the surface of the surface layer, and a distance from the hole closest to the surface of the substrate to the surface of the substrate is more than 0 and 2000 nm or less.

2. The electrode for electrolysis according to claim 1, wherein the substrate is a conductive substrate.

3. The electrode for electrolysis according to claim 2, wherein the dielectric material included in the surface layer is an oxide.

4. The electrode for electrolysis according to claim 3, wherein the oxide is tantalum oxide, aluminum oxide, titanium oxide or tungsten oxide.

5. The electrode for electrolysis according to any one of claims 1 to 4, wherein on the substrate, there is formed an intermediate layer positioned on an inner side of the surface layer, formed on the surface of the substrate and containing at least one of an oxidization retarding metal, a metal oxide having conductivity and a metal having conductivity even when oxidized, and
the distance from the hole closest to the intermediate layer to the intermediate layer is more than 0 and 2000 nm or less.

6. The electrode for electrolysis according to claim 5, wherein the intermediate layer contains one of a noble metal, an alloy including the noble metal and a noble metal oxide.

7. The electrode for electrolysis according to claim 6, wherein the noble metal is platinum.

8. A method of manufacturing an electrode for electrolysis according to claims 5 to 7, the method including:
a first step of applying an intermediate layer constituting material to the surface of a substrate, and thermally treating the surface of the substrate to form an intermediate layer on the surface of the substrate; and
a second step of applying a surface layer constituting material to the surface of the intermediate layer, and thermally treating the surface of the intermediate layer in an oxidizing atmosphere to form a surface layer on the surface of the intermediate layer.

9. The method of manufacturing the electrode for electrolysis according to claim 8, wherein the thermal treatment in the second step is executed at a temperature higher than that of the thermal treatment in the first step.
